(19) United States
(12) Patent Application Publication
(10) Pub. No.: US 2025/0166937 A1
(43) Pub. Date: May 22, 2025

(54) MULTI-SWITCH CONTACTOR ASSEMBLY

(71) Applicant: SENSATA TECHNOLOGIES, INC., ATTLEBORO, MA (US)

(72) Inventors: CORY Z. BOUSQUET, UXBRIDGE, MA (US); PAUL GENNISSEN, MARKELO (NL); ENGBERTUS BERKEL, WIERDEN (NL); ERNIE JOHANNUS ANTONIUS SCHOOT UITERKAMP, HEETEN (NL)

(21) Appl. No.: 18/839,206

(22) PCT Filed: Mar. 3, 2023
(86) PCT No.: PCT/US2023/063658

§ 371 Date: Aug. 16, 2024

Related U.S. Application Data
(60) Provisional application No. 63/368,249, filed on Jul. 12, 2022.
(60) Provisional application No. 63/316,116, filed on Mar. 3, 2022.

(51) Int. Cl. H01H 3/42; H01H 3/40

(52) U.S. Cl. CPC H01H 3/42; H01H 3/40

(57) ABSTRACT

In an embodiment, a multi-switch contactor assembly includes an array of at least three switches, the array including a first switch comprising a first moveable contact and at least one first fixed contact, the first switch configured to change a switch state between an open state and a closed state; a second switch comprising a second moveable contact and at least one fixed second contact, the second switch configured to change a switch state between an open state and a closed state; and a third switch comprising a third moveable contact and at least one third fixed contact, the third switch configured to change a switch state between an open state and a closed state. The multi-switch contactor assembly further includes an actuator assembly configured to actuate the first moveable contact, the second moveable contact, and the third moveable contact, the actuator assembly including a shaft, wherein the respective switch states of the three switches is change in dependence upon rotation of the shaft.

### BACKGROUND

Electromechanical switching devices, such as contactors and relays, are designed to carry a certain amount of electrical current for certain periods of time. Such devices are particularly important in electric vehicles. Typically, electric vehicles have multiple electromechanical switches that open or close high current paths between the battery packs and the electrical system. These switches are controlled by different actuation mechanisms. To prevent short circuit of the battery packs, electromechanical switching elements of the battery configuration contactor must withstand mechanical shock and coordinate multiple switches to change a battery connection configuration.

### SUMMARY

To avoid unwanted switch combinations, a multi-switch contactor assembly is provided in which a single mechanical actuation mechanism operates multiple switches in such a way that dangerous switch combinations are mechanically impossible. In a particular example, multiple switches may be actuated by multiple cams that are coupled to the same cam shaft. Different combinations of switch states (open or closed) among the multiple switches are realized through rotation of the cam shaft. This provides a limited set of configuration states controllable by a single actuator. Different cam shapes or different orientations of the cams on the cam shaft may be used to realize the different switch state combinations. This provides low contact resistance and high contact force while not requiring power to keep the switches in a particular state.

A particular embodiment is directed to a multi-switch contactor assembly comprising an array of at least three switches, the array including a first switch comprising a first moveable contact and at least one first fixed contact, the first switch configured to change a switch state between an open state and a closed state; a second switch comprising a second moveable contact and at least one fixed second contact, the second switch configured to change a switch state between an open state and a closed state; and a third switch comprising a third moveable contact and at least one third fixed contact, the third switch configured to change a switch state between an open state and a closed state. The multi-switch contactor assembly further includes an actuator assembly configured to actuate the first moveable contact, the second moveable contact, and the third moveable contact, the actuator assembly including a shaft, wherein the respective switch states of the three switches is changed in dependence upon rotation of the shaft.

In some examples, rotation of the shaft changes the switch state of the first switch to the closed state while changing the switch state of the third switch to the open state. In some examples, the multi-switch contactor assembly is configured for four switch state combinations of the three switches. In some examples, clockwise and counterclockwise rotation of the shaft selects among the four switch state combinations.

In some variations, the actuator assembly includes three cams that are rotatable through rotation of the shaft, the three cams configured to respectively actuate the three switches based on the rotation of the shaft. Each of the three cams may be coupled to the cam shaft, where at least two cams differ in their shape. Each of the three cams may include an actuation member, where the actuation members of at least two cams are unaligned along the shaft. In some examples, the first moveable contact, the second moveable contact, and the third moveable contact are spring loaded such that the three switches have a normally closed state, where respective switches are changed to an open state through actuation of respective moveable contacts by respective cams. In other examples, the first moveable contact, the second moveable contact, and the third moveable contact are spring loaded such that the three switches have a normally open state, where respective switches are changed to a closed state through actuation of respective moveable contacts by respective cams.

In some examples, the multi-switch contactor assembly of claim 9 further comprises an electromagnet, where a particular switch automatically opens when the electromagnet is de-energized. In some examples, the first moveable contact, the second moveable contact, and the third moveable contact are at least one of rotatable and deformable.

In some variations, the actuator assembly includes three worm gears each including one of the three cams; wherein the shaft is a worm drive shaft, where rotation of the worm drive shaft rotates the three worm gears such that the three cams are also rotated.

In some variations, the first moveable contact includes a first portion in continuous contact with a first bus bar and a second portion that makes and breaks contact with a second bus bar depending on the rotation of the shaft, where the second moveable contact includes a first portion in continuous contact with a third bus bar and a second portion that makes and breaks contact with a fourth bus bar depending on the rotation of the shaft, and where the third moveable contact includes a first portion in continuous contact with a fifth bus bar and a second portion that makes and breaks contact with a sixth bus bar depending on the rotation of the shaft.

Another embodiment is directed to a system for multi-switch contactor assembly, the system comprising a first power source, a second power source, a power distribution system; and the multi-switch contactor assembly. The multi-switch contactor assembly includes an array of at least three switches, the array including a first switch comprising a first moveable contact and at least one first fixed contact, the first switch configured to change a switch state between an open state and a closed state; a second switch comprising a second moveable contact and at least one fixed second contact, the second switch configured to change a switch state between an open state and a closed state; and a third switch comprising a third moveable contact and at least one third fixed contact, the third switch configured to change a switch state between an open state and a closed state. The multi-switch contactor assembly also includes an actuator assembly configured to actuate the first moveable contact, the second moveable contact, and the third moveable contact, the actuator assembly including a shaft, wherein rotation of the shaft changes the switch state of at least one of the three switches.

In some examples, the first switch is configured to connect the first power source and the power distribution system, the second switch is configured to connect the second power source and the power distribution system, and the third switch configured to connect the first power source and the second power source in series to the power distribution system.

In some examples, the first switch and the second switch are closed only when the third switch is open and the third switch is closed only when the first switch and the second switch are open.

In some examples, the multi-switch contactor assembly is configured to connect the power distribution system and the first power source and the second power source in only two configuration states. In a first configuration state of the multi-switch contactor assembly, the first switch and the second switch are closed, such that the first power source and the second power source are connected to the power distribution system in parallel and the third switch is open. In a second configuration state of the multi-switch contactor assembly, the first switch and the second switch are open and the third switch is closed, such that the first power source and the second power source are connected in series.

In some examples, the multi-switch contactor assembly is configured to connect the power distribution system and the first power source and the second power source in only four configuration states. In a first configuration state of the multi-switch contactor assembly, the first switch and the second switch are closed, such that the first power source and the second power source are connected to the power distribution system in parallel and the third switch is open. In a second configuration state of the multi-switch contactor assembly, the first switch and the second switch are open and the third switch is closed, such that the first power source and the second power source are connected in series. In a third configuration state of the multi-switch contactor assembly, the first switch is closed, such that the first power source is directly connected to the power distribution system, and the second switch and the third switch are open. In a fourth configuration state of the multi-switch contactor assembly, the second switch is closed, such that the second power source is directly connected to the power distribution system, and the first switch and the third switch are open.

Another embodiment is directed to a method for a multi-switch contactor assembly. The method includes connecting the multi-switch contactor assembly to a power distribution system and two or more power sources. The multi-switch contactor assembly includes an array of at least three switches, the array including a first switch comprising a first moveable contact and at least one first fixed contact, the first switch configured to change a switch state between an open state and a closed state; a second switch comprising a second moveable contact and at least one fixed second contact, the second switch configured to change a switch state between an open state and a closed state; and a third switch comprising a third moveable contact and at least one third fixed contact, the third switch configured to change a switch state between an open state and a closed state. The multi-switch contactor assembly also includes an actuator assembly configured to actuate the first moveable contact, the second moveable contact, and the third moveable contact, the actuator assembly including a shaft, wherein rotation of the shaft changes the switch state of at least one of the three switches.

The method also includes energizing the actuator assembly to move the multi-switch contactor assembly from a first state to a second state, where, in the first state, the first switch and the second switch are closed only when the third switch is open. In the second state, the third switch is closed only when the first switch and the second switch are open. In some examples, the actuator assembly includes three cams that are rotatable through rotation of the shaft, the three cams configured to respectively actuate the three switches based on the rotation of the shaft.

### BRIEF DESCRIPTION OF THE DRAWINGS

FIG. 1 is a schematic for a multi-switch contactor assembly for a battery configuration contactor in accordance with at least one embodiment of the present disclosure.

FIG. 2A is a diagram of a first state of an example switch assembly for a multi-switch contactor assembly in accordance with at least one embodiment of the present disclosure.

FIG. 2B is another state of another example switch assembly of FIG. 2B.

FIG. 3 is a diagram of configuration states for a multi-switch contactor assembly in accordance with at least one embodiment of the present disclosure.

FIG. 4 is an exploded view of a multi-switch contactor assembly in accordance with at least one embodiment of the present disclosure.

FIG. 5A sets forth a diagram of another example switch assembly for a multi-switch contactor assembly in accordance with at least one embodiment of the present disclosure.

FIG. 5B sets forth another view of the switch assembly of FIG. 5A.

FIG. 6A sets forth a diagram of another example switch assembly for a multi-switch contactor assembly in accordance with at least one embodiment of the present disclosure.

FIG. 6B sets forth another view of the switch assembly of FIG. 6A.

FIG. 6C sets forth another view of the switch assembly of FIG. 6A.

FIG. 7 illustrates different cam shapes in accordance with embodiments of the present disclosure.

FIG. 8A is a diagram of another example switch assembly for a multi-switch contactor assembly in accordance with at least one embodiment of the present disclosure.

FIG. 8B is another view of the example switch assembly of FIG. 8A.

FIG. 8C is a perspective view another example switch assembly in accordance with at least one embodiment of the present disclosure.

FIG. 8D is a front view the example switch assembly of FIG. 8C.

FIG. 9 is another example multi-switch contactor assembly in accordance with at least one embodiment of the present disclosure.

FIG. 10A is a front view of a first state of another example multi-switch contactor assembly in accordance with at least one embodiment of the present disclosure.

FIG. 10B is a front view of another state of the example multi-switch contactor assembly of FIG. 10A.

FIG. 10C is a front view of another state of the example multi-switch contactor assembly of FIG. 10A.

FIG. 10D is a front view of another state of the example multi-switch contactor assembly of FIG. 10A.

FIG. 10E is a perspective view the example multi-switch contactor assembly of FIG. 10A.

FIG. 11A is an example rotatable moveable contact of the example multi-switch contactor assembly of FIG. 10A.

FIG. 11B is another view of the rotatable moveable contact of FIG. 11A.

FIG. 12 is a flowchart of an example method of a multi-switch contactor assembly according to at least one embodiment of the present disclosure.

### DETAILED DESCRIPTION

Connecting and disconnecting electrical circuits is as old as electrical circuits themselves and is often utilized as a method of switching power to a connected electrical device between “on” and “off” states. An example of one device commonly utilized to connect and disconnect circuits is a contactor, which is electrically connected to one or more devices or power sources. A contactor is configured such that it can change between “open” and “closed” states to interrupt or complete a circuit to control electrical power to and from a device.

As society advances, various innovations have resulted in electrical systems and electronic devices becoming increasingly common. An example of such innovations includes recent advances in electrical automobiles, which are becoming the energy-efficient standard and will likely replace most traditional petroleum-powered vehicles. In such expensive and routinely used electrical devices, overcurrent protection is particularly applicable to prevent device malfunction and prevent permanent damage to the devices. Furthermore, overcurrent protection can prevent safety hazards, such as electrical shock or electrical fires. These modern improvements to electrical systems and devices require improved solutions to increase the safety, reliability, and efficiency of mechanisms for triggering contactors.

Described herein are different embodiments of contact assemblies having certain components, or portions thereof, that are formed integral to one another to improve the operation characteristics and increase operational reliability and safety. The present invention also provides for new features of components of the contact assemblies, with these features providing the desired operational characteristics, performance and safety. Embodiments of the invention are also directed to contactors (i.e., electrical switching devices) utilizing the contactor assemblies according to the present invention, and to electrical circuits and systems utilizing the electrical switching devices according to the present invention.

The terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e. only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

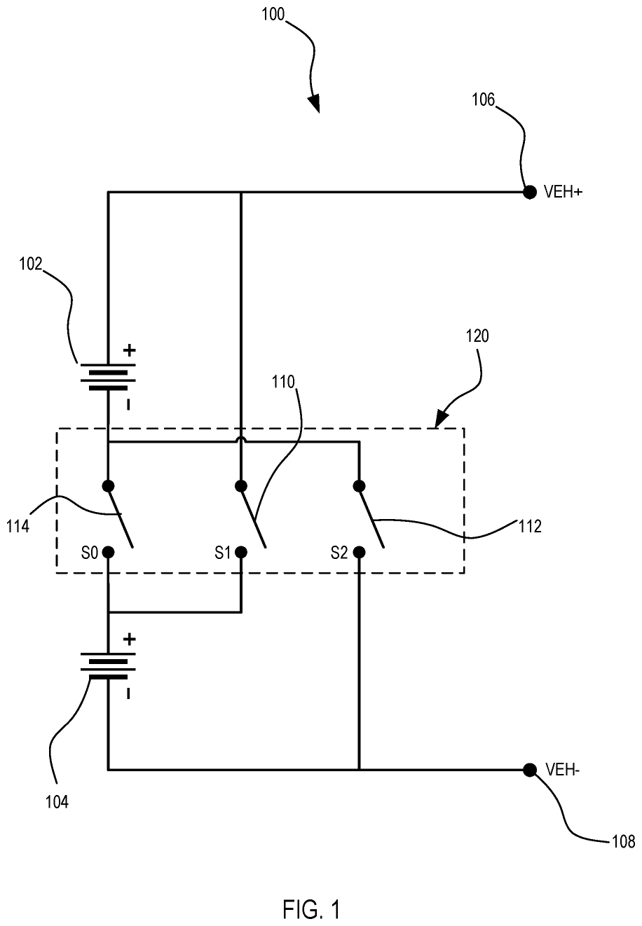

Exemplary methods and apparatuses for a multi-switch contactor assembly in accordance with the present disclosure are described with reference to the accompanying drawings, beginning with FIG. 1. FIG. 1 sets forth a battery configuration contactor circuit 100 employing a multi-switch contactor assembly in accordance with at least one embodiment of the present disclosure. The battery configuration contactor may be employed in an electric vehicle for connecting multiple battery packs to a vehicle power distribution system for driving the electric vehicle as well as for charging the battery packs. In this example, a first switch 110 (referred to herein as ‘S1’) is operable to open and close a connection between the positive terminal of a first battery pack 104 and a positive terminal 106 of a vehicle power distribution system. The negative terminal of the first battery pack 104 is connected to a negative terminal 108 of the vehicle power distribution system. In this example, a second switch 112 (referred to herein as ‘S2’) is operable to open and close a connection between the negative terminal of a second battery pack 102 and the negative terminal 108 of the vehicle power distribution system. A positive terminal of the second battery pack 102 is connected to the positive terminal 106 of the vehicle power distribution system. In this example, the third switch 114 (referred to herein as ‘S0’) is operable to open and close a series connection of the battery packs 102, 104. When the first switch 110 is closed, the first battery pack 104 is directly connected to the vehicle power distribution system. When the second switch 112 is closed, the second battery pack 102 is directly connected to the vehicle power distribution system. When the first switch 110 and the second switch 112 are closed, both battery packs 102, 104 are connected in parallel to the vehicle power distribution system. When the third switch 114 is closed, both battery packs 102, 104 are connected in series to the vehicle power distribution system. However, closing either the first switch 110 or the second switch 112 while the third switch 114 is closed may cause a direct short circuit of the battery packs 102, 104, which may weld the contactors of the switches and/or cause harm to the battery packs 102, 104. To prevent this, there is a high requirement on switch contactors to withstand mechanical shock. Solenoid contactor coils require constant power when enabled.

Thus, in accordance with some embodiments of the present disclosure, a battery configuration contactor utilizes a multi-switch contactor assembly 120 in which switches S0, S1, and S2 are mechanically linked to prevent switch S0 from being opened while switch S1 or switch S2 is closed, and vice versa. A multi-switch contactor assembly in accordance with at least one embodiment of the present disclosure comprises an array of switches (e.g., switches S0, S1, S2) including a first switch implemented by a first moveable contact and at least one first fixed contact, the first switch configured to change a switch state between an open state and a closed state; a second switch implemented by a second moveable contact and at least one fixed second contact, the second switch configured to change a switch state between an open state and a closed state; and a third switch implemented by a third moveable contact and at least one third fixed contact, the third switch configured to change a switch state between an open state and a closed state. The multi-switch contactor assembly further includes an actuator assembly configured to actuate the first moveable contact, the second moveable contact, and the third moveable contact. The actuator assembly includes a shaft, wherein the respective switch states of the three switches is changed in dependence upon rotation of the shaft. Although a multi-switch contactor assembly is described in the following examples as including three switches, the principles of the present disclosure are applicable to a multi-switch contactor assembly comprising fewer than three switches or more than three switches. That is, a single actuator is employed to change multiple switches to differing switch states such that some combinations of switch states are mechanically prohibited. As will be shown in more detail below, mechanical linkage of the contactor switches can be achieved with low contact resistance, no levitation, no hold power, and high contact forces.

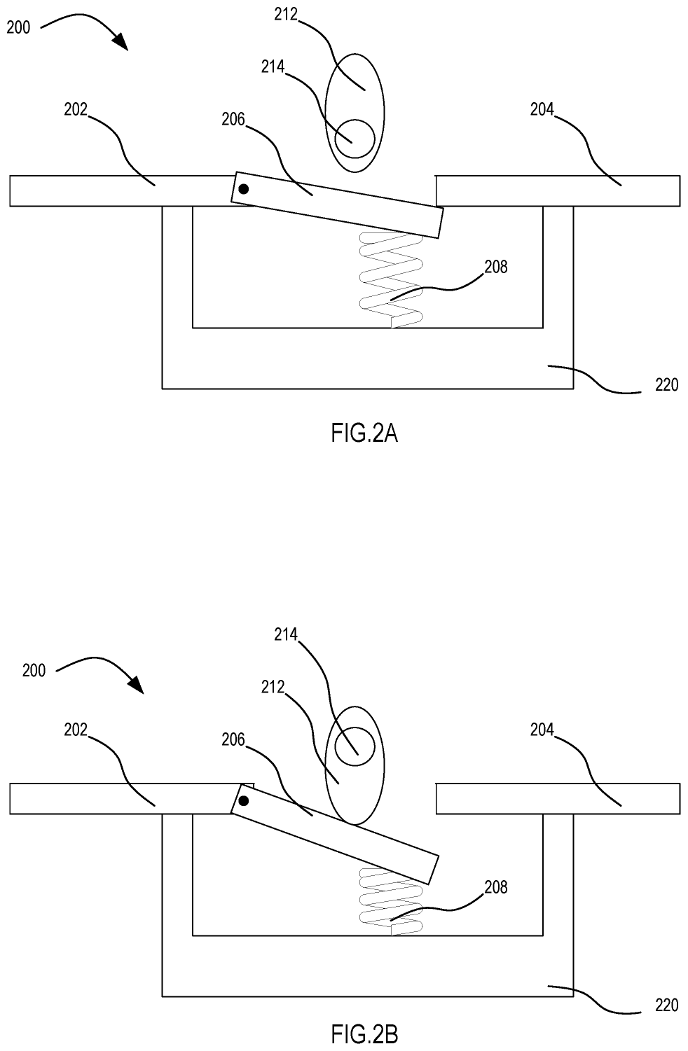

For further explanation, FIGS. 2A and 2B illustrate an example of one switch assembly 200 for a multi-switch contactor assembly in accordance with at least one embodiment of the present disclosure. The switch assembly 200 includes fixed contacts 202, 204 and a moveable contact 206. The moveable contact 206 is coupled at one end to a fixed contact 202. The moveable contact 206 may be rotatable, flexible, or deformable. An opposite end is coupled to a spring 208 that is held by a support structure 220 (e.g., a contactor housing). In a first state, the moveable contact 206 is held in the closed position by the spring 208. To transition to a second state, the moveable contact 206 is moved through application of force to the moveable contact 206 by a rotatable cam 212, causing separation of the moveable contact 206 from the fixed contact and compression of the spring, thus placing the contactor assembly 200 in the open state. To transition the switch assembly 200 to the second state, the cam 212 is rotated out of contact with the moveable contact 206, allowing the spring 208 to apply a force to the moveable contact 206 to move into contact with the fixed contact 204, thus placing the switch assembly in the closed state. The cam 212 rotates via a shaft 214. In some examples, multiple cams 212 may be coupled to the same shaft 214, thus providing a mechanical link to the actuation of multiple moveable contacts corresponding to multiple switches of the multi-switch contactor assembly.

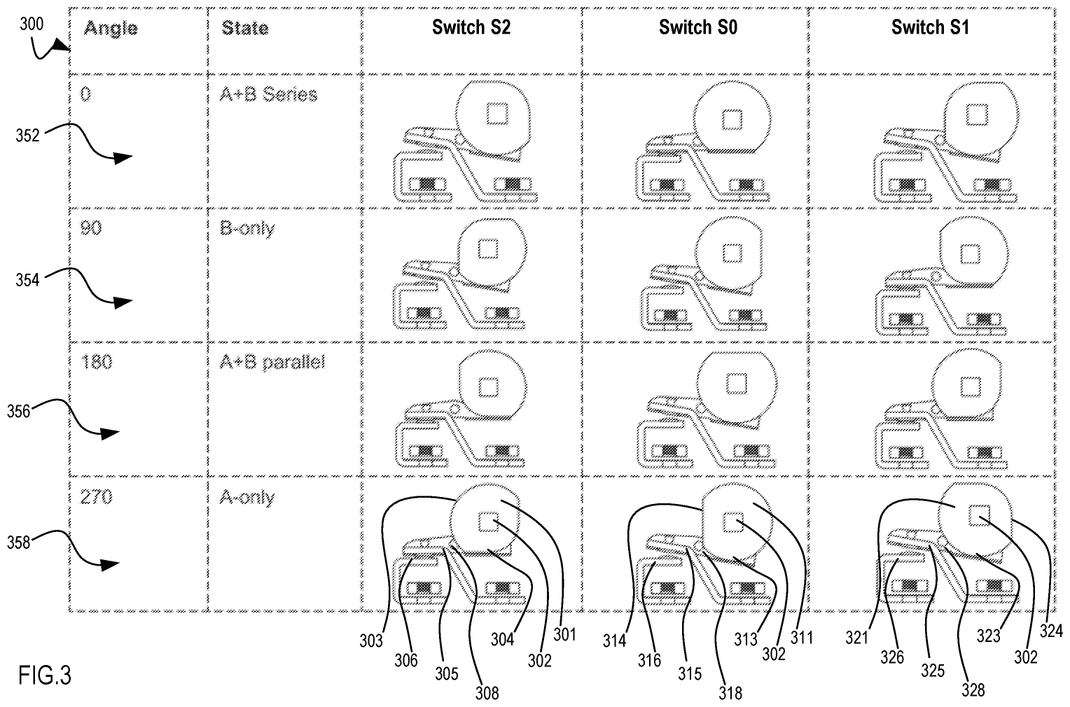

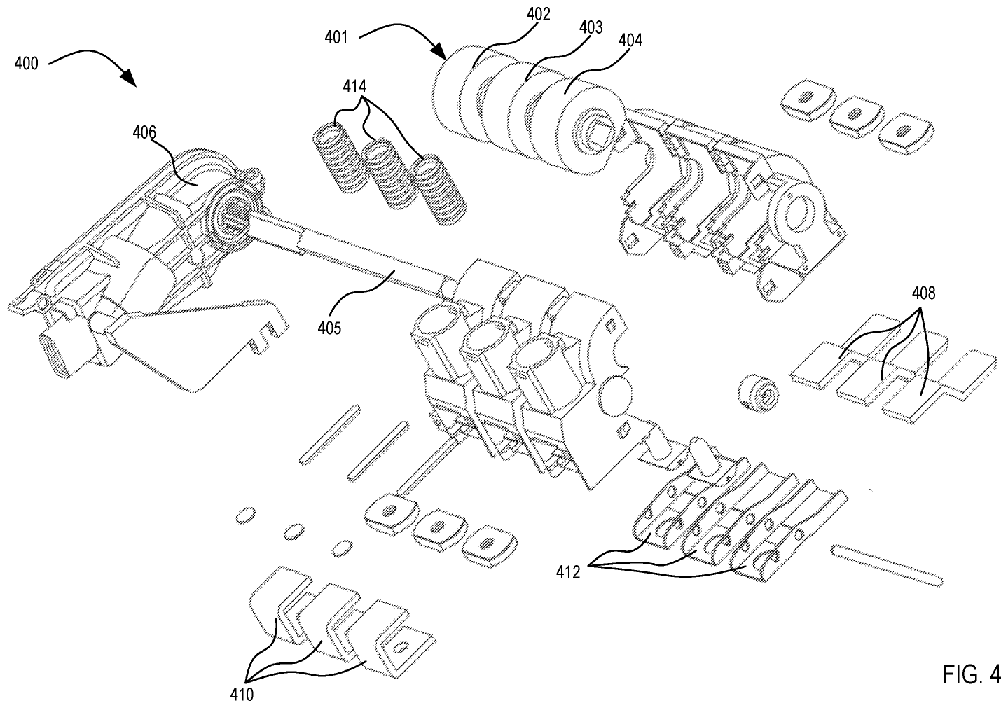

For further reference, FIG. 3 sets forth diagram 300 of configuration states for a multi-switch contactor assembly in accordance with at least one embodiment of the present disclosure. The diagram 300 shows the state of three switch assemblies S0, S1, S2 based on the rotation of a cam shaft 302. To aid illustration, three switch assemblies S0, S1, S2 may be comprised in a battery configuration contactor configured to connect battery pack A and battery pack B to a vehicle power distribution system. In such an example, battery pack A may correspond to battery pack 102 of FIG. 1 and battery pack B may correspond to battery pack 104 of FIG. 1, where switch assembly S2 corresponds to switch 112, switch assembly S1 corresponds to switch 110, and switch assembly S0 corresponds to switch 114 in FIG. 1. However, it should be appreciated that the configuration shown in FIG. 3 may be applied to other vehicle contactors such as a fast charge contactor, an auxiliary or utility contactor, as well as contactors for applications other than vehicles. Switch assemblies S0, S1, S2 may be arrayed in an orientation parallel to the axis of cam shaft 302 (e.g., as shown in FIG. 4), such that rotation of the cam shaft changes the switch state of at least one of the switches. In this example, a 180 degree rotation changes the switch states of all of the switches. Three cams 301, 311, 321 are coupled to the cam shaft 302, which together form an actuation assembly for all of the switch assemblies.

In the example of FIG. 3, a first switch assembly S2 includes a fixed bus bar 306 (i.e., a fixed contact) and a deformable bus bar 305 (i.e., a moveable contact). Switch assembly S2 further includes a rocker 308 coupled to the deformable bus bar 305. In this example, switch assembly S2 is a ‘normally closed’ switch in that the deformable bus bar 305 is in contact with the fixed bus bar 306 unless the rocker 308 is actuated to deform the deformable bus bar 305 such that contact between the deformable bus bar 305 and the fixed bus bar 306 is broken, thereby opening the switch. In some examples, the rocker 308 is spring loaded to hold the deformable bus bar 305 in contact with the fixed bus bar 306 unless a force applied to the rocker 308 by the cam 301 exceeds a spring bias force. The rocker 308 is actuated by the cam 301, which includes a substantially round portion 303 and one or more substantially flat portions 304. When the substantially round portion 303 of the cam 301 engages the rocker 308, one end of the rocker proximate to the cam 301 is forced downward thus forcing the other end of the rocker 308 and the deformable bus bar 305 upward, moving the deformable bus bar 305 out of contact with the fixed bus bar 306. When the substantially flat portion 304 of the cam 301 engages the rocker 308, the end of the rocker 308 proximate to the cam 301 is allowed to return to a closed state position in which the rocker 308 facilitates contact between the deformable bus bar 305 and the fixed bus bar 306. In this example, cam 301 include two substantially flat portions 304, one corresponding to a closed switch state for a direct connection of battery pack A only and one corresponding to a closed switch state for parallel connection of battery pack A and battery pack B. Thus, rotation of the cam 301 opens and closes the switch S2 depending on the rotation of the cam shaft 302 and whether the rocker 308 is engaged by the substantially round portion 303 or the substantially flat portion of the cam. In alternative embodiments, switch S2 may be arranged a ‘normally open’ switch in which the cam 301 actuates the rocker 308 to move the deformable bus bar 305 into contact with the fixed bus bar 306.

In the example of FIG. 3, like switch assembly S2, second switch assembly S1 includes a fixed bus bar 326 (i.e., a fixed contact) and a deformable bus bar 325 (i.e., a moveable contact). Switch assembly S1 further includes a rocker 328 coupled to the deformable bus bar 325. In this example, switch assembly S1 is a ‘normally closed’ switch in that the deformable bus bar 325 is in contact with the fixed bus bar 326 unless the rocker 328 is actuated to deform the deformable bus bar 325 such that contact between the deformable bus bar 325 and the fixed bus bar 326 is broken, thereby opening the switch. In some examples, the rocker 328 is spring loaded to hold the deformable bus bar 325 in contact with the fixed bus bar 326 unless a force applied to the rocker 328 by the cam 321 exceeds a spring bias force. The rocker 328 is actuated by the cam 321, which includes a substantially round portion 323 and one or more substantially flat portions 324. When the substantially round portion 323 of the cam 321 engages the rocker 328, one end of the rocker proximate to the cam 321 is forced downward thus forcing the other end of the rocker 328 and the deformable bus bar 325 upward, moving the deformable bus bar 325 out of contact with the fixed bus bar 326. When the substantially flat portion 324 of the cam 321 engages the rocker 328, the end of the rocker 328 proximate to the cam 321 is allowed to return to a closed state position in which the rocker 328 facilitates contact between the deformable bus bar 325 and the fixed bus bar 326. In this example, cam 321 include two substantially flat portions 324, one corresponding to a closed switch state for a direct connection of battery pack B only and one corresponding to a closed switch state for parallel connection of battery pack A and battery pack B. Thus, rotation of the cam 321 opens and closes the switch S1 depending on the rotation of the cam shaft 302 and whether the rocker 328 is engaged by the substantially round portion 323 or the substantially flat portion of the cam. In alternative embodiments, switch S1 may be arranged a ‘normally open’ switch in which the cam 321 actuates the rocker 328 to move the deformable bus bar 325 into contact with the fixed bus bar 326.

In the example of FIG. 3, like switch assembly S2, third switch assembly S0 includes a fixed bus bar 316 (i.e., a fixed contact) and a deformable bus bar 315 (i.e., a moveable contact). Switch assembly S0 further includes a rocker 318 coupled to the deformable bus bar 315. In this example, switch assembly S0 is a ‘normally closed’ switch in that the deformable bus bar 315 is in contact with the fixed bus bar 316 unless the rocker 318 is actuated to deform the deformable bus bar 315 such that contact between the deformable bus bar 315 and the fixed bus bar 316 is broken, thereby opening the switch. In some examples, the rocker 318 is spring loaded to hold the deformable bus bar 315 in contact with the fixed bus bar 316 unless a force applied to the rocker 318 by the cam 311 exceeds a spring bias force. The rocker 318 is actuated by the cam 311, which includes a substantially round portion 313 and one or more substantially flat portions 314. When the substantially round portion 313 of the cam 311 engages the rocker 318, one end of the rocker proximate to the cam 311 is forced downward thus forcing the other end of the rocker 318 and the deformable bus bar 315 upward, moving the deformable bus bar 315 out of contact with the fixed bus bar 316. When the substantially flat portion 314 of the cam 311 engages the rocker 318, the end of the rocker 318 proximate to the cam 311 is allowed to return to a closed state position in which the rocker 318 facilitates contact between the deformable bus bar 315 and the fixed bus bar 316. In this example, cam 311 include one substantially flat portion 314 corresponding to a closed switch state for series connection of battery pack A and battery pack B. Thus, rotation of the cam 311 opens and closes the switch S0 depending on the rotation of the cam shaft 302 and whether the rocker 318 is engaged by the substantially round portion 313 or the substantially flat portion of the cam. In alternative embodiments, switch S0 may be arranged a ‘normally open’ switch in which the cam 311 actuates the rocker 318 to move the deformable bus bar 315 into contact with the fixed bus bar 316.

The diagram 300 of multi-switch contactor assembly configuration states includes four distinct states. In a first state 352, the cam shaft is at 0 degrees of rotation. Cams 301, 321 apply a force to rockers 308, 328 to ensure that switch assemblies S2, S1 are in an open state when the rocker 318 of switch assembly S0 engages the substantially flat portion 314 of cam 311 and allowing switch assembly S0 to close at 0 degrees rotation. Thus, a parallel or direct connection of battery pack A and battery pack B is mechanically prevented while switch assembly S0 connects battery pack A and battery pack B in series.

In a second state 354, the cam shaft 302 is at 90 degrees (e.g., counterclockwise) rotation relative to state 352. Cam 311 applies a force to the rocker 318 to open the switch assembly S0 before the rocker 328 of switch assembly S1 engages a substantially flat portion 324 of cam 321 of switch assembly S1 at 90 degrees rotation. When the rocker 328 engages the substantially flat portion 324 of the cam 321, the switch assembly S1 closes. Thus, a series connection of battery pack A and battery pack B is mechanically prevented while switch assembly S1 connects battery pack B directly to the power distribution system. Cam 301 continues to apply a force to rocker 308 to retain switch assembly S2 in the open state.

In a third state 356, the cam shaft 302 is at 180 degrees rotation (e.g., counterclockwise) relative to state 352. Cam 311 continues to apply a force to the rocker 318 to keep the switch assembly S0 in the open state. The rocker 328 of switch assembly S1 engages a second substantially flat portion 324 of cam 321 of switch assembly S1 at 180 degrees rotation such that the switch assembly S1 is maintained in the closed state. At the same time, rocker 308 of switch assembly S2 engages a first substantially flat portion 304 of the cam 301 of switch assembly S2, thus allowing switch assembly S2 to transition to the closed state. Thus, a series connection of battery pack A and battery pack B is mechanically prevented while switch assembly S1 and switch assembly S2 connect battery pack A and battery pack B in parallel to the power distribution system.

In a fourth state 358, the cam shaft is at 270 degrees rotation (e.g., counterclockwise) or −90 degrees rotation (e.g., clockwise) relative to state 352. Cam 311 continues to apply a force to the rocker 318 to keep the switch assembly S0 in the open state. Cam 321 applies a force to the rocker 328 to keep the switch assembly S1 in the open state. At 270 degrees rotation rocker 308 of switch assembly S2 engages a second substantially flat portion of the cam 301 of switch assembly S2, thus allowing switch assembly S2 to transition to the closed state. Thus, a series connection of battery pack A and battery pack B is mechanically prevented while switch assembly S2 connects battery pack A directly to the power distribution system.

In some examples, as shown in FIG. 3, the state of switch assembly S1 may be maintained in the closed state while the switch assembly S2 transitions to the closed state between 90 and 180 degrees. In other examples, a break-before-make arrangement is employed such that all switch assemblies S0, S1, S2 are in the open state when rotation of the cam shaft is not at either 0, 90, 180, or 270 (−90) degrees rotation. In some examples, a position sensor is used to determine an absolute rotation of the cam shaft. Thus, the multi-switch contactor assembly only has four distinct states where at least one battery pack is connected to the power distribution system, and where a series connection of the battery packs is mechanically prevented when a direct or parallel connection of the battery packs is made.

It will be appreciated that other cam shapes may be utilized instead of a cam having round portions and flat portions. For example, a notch may be employed instead of a flat façade. In other examples, the switch assemblies may comprise ‘normally open’ switches, where a lobe or other protruding actuation member applies a force on the deformable contact to make contact with the fixed contact and closed the switch. In some variations, combinations of ‘normally open’ and ‘normally closed’ switches may be used in the same array of switches.

It will be appreciated that two or more cams having different cam shapes may be employed to realize different switch states in the corresponding switches. Similarly, two or more cams having the same shape but different orientations on the cam shaft may be employed to realize different switch states in the corresponding switches. In some cases, two cams may have the same shape and the same orientation on the cam shaft such that the cams actuate the same switch state on the corresponding switches (e.g., to reduce the current per contact). Thus, the multiple cams corresponding to the multiple switches may vary by shape, orientation, or alignment, where all cams are actuated by the same cam shaft.

It will be further appreciated that a deformable bus bar may be replaced with a fixed bus bar coupled to a rotatable or pivotable moveable contact.

It will be further appreciated that the multi-switch contactor assembly in accordance with FIGS. 2 and 3 may be applied in a battery configuration contactor as well as other devices constructed as above with different cam shape to enable high voltage high current connections that require low contactor resistance, like fast charging contactors, or that require no device current consumption, like axillary contactors used, for example, in vehicle to grid systems.

In view of the foregoing, a multi-switch contactor assembly in accordance with FIGS. 2 and 3 is provided in which 1) a single mechanical actuation mechanism operates all switches in such a way that dangerous switch combinations are mechanically impossible; 2) there are only four possible main states: series, only battery A connected, only battery B connected, A+B connected parallel, and intermediate states may be defined in which all contacts are open; 3) the actuator can move in forward and reverse direction to allow either the connection A only or B only to be made first after a series or parallel configuration; 4) the actuator assembly does not draw any power once the desired connection state is achieved; 5) a very high contact force (e.g., 100N) enabling very low device resistance (e.g., <50 uOhm) and high levitation currents (>25 kA) is provided; 6) contact can be made using a single contact and flexible bus bars, or a double moveable contact using a rigid contact.

FIG. 4 sets forth an exploded view of an example multi-switch contactor assembly 400 in accordance with at least one embodiment of the present disclosure. The example contactor assembly 400 includes a cam assembly 401 including three cams 402, 403, 404 that are coupled to a cam shaft 405, where rotation of the cam shaft is driven by a motor 406. The contactor assembly includes three switch assemblies each comprising a fixed contact 410 and a deformable contact 408. The cams 402, 403, 404 act on respective rockers 412 to deform respective deformable contacts 408 and open the respective switches. When a rocker 412 is engaged by a flat façade of a cam, a bias spring 414 forces the rocker to a closed state position in which the deformable contact 408 is held in contact with the fixed contact 410. When the rocker 412 is engaged by the round portion of the cam, the cam applies a force on the rocker 412 that overcomes the bias force of the spring 414, thus forcing the rocker 412 into an open state position and causing the rocker 412 to bend the deformable contact 408 out of contact with the fixed contact 410. In some examples, the multi-switch contactor assembly 400 includes a position sensor (not shown) to detect the rotation of the cam shaft 405. The position sensor provides the absolute angle of the cam shaft such that the cam shaft can be rotated to a new setpoint to change switch states. The position sensor may be, for example, a non-contacting position sensor and a contacting device (e.g., a potentiometer).

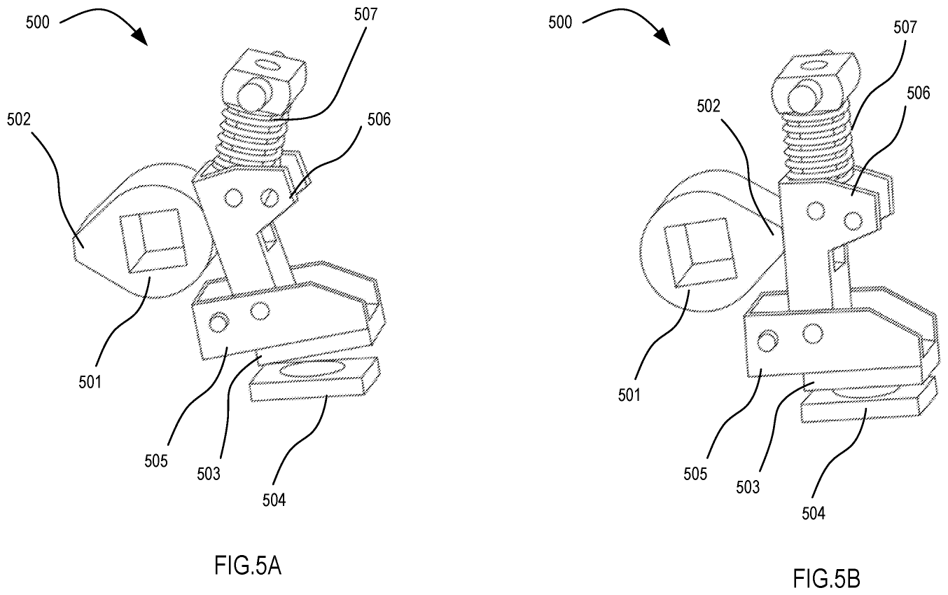

FIGS. 5A and 5B set forth another example switch assembly 500 in accordance with at least one embodiment of the present disclosure. The switch assembly 500 has a ‘normally open’ switch configuration. The switch assembly 500 includes a moveable contact 503 and a fixed contact 504. In some examples, the moveable contact 503 is a deformable bus bar and the fixed contact 504 is a fixed bus bar. The moveable contact 503 is supported by a contact rocker 505 that is coupled to a contact actuator 506. A contact spring 507 applies a bias force on the contact actuator 506 to bias the moveable contact 503 in a normally open state, as shown in FIG. 5A. The switch assembly 500 also includes a cam 501 that is couplable to a cam shaft (not shown). The cam 501 includes an actuation member 502, shown in FIGS. 5A and 5B as a lobe. As the cam shaft rotates the cam 501, the actuation member 502 applies a force to the contact actuator 506 that overcomes the bias force provided by the contact spring 507. The force applied by the actuation member 502 on the contact actuator 506 is transferred to the contact rocker 505, which drives the moveable contact 503 downward toward the fixed contact 504 until the moveable contact 503 makes contact with the fixed contact 504 and closes the switch, as shown in FIG. 5B. Once rotation of the cam 501 closes the switch, the cam 501 is retained in position to keep the switch closed until the cam rotates further, allowing the switch to open again through application of the bias force from the contact spring 507. It will be appreciated that multiple instances of the switch assembly 500 may be arrayed such that multiple cams 501 of differing shapes or orientations can be coupled to the same cam shaft, as discussed above.

In view of the foregoing, a multi-switch contactor assembly, employing multiple instances of the switch assembly 500 in accordance with FIGS. 5A and 5B, is provided in which 1) a single mechanical actuation mechanism operates all switches in such a way that dangerous switch combinations are mechanically impossible; 2) there are only four possible main states: series, only battery A connected, only battery B connected, A+B connected parallel, and intermediate states may be defined in which all contacts are open; 3) the actuator can move in forward and reverse direction to allow either the connection A only or B only to be made first after a series or parallel configuration; 4) the actuator assembly does not draw any power once the desired connection state is achieved; 5) a very high contact force (e.g., 100N) enabling very low device resistance (e.g., <50 uOhm) and high levitation currents (>25 kA) is provided; 6) contact can be made using a single contact and flexible bus bars, or a double moveable contact using a rigid contact.

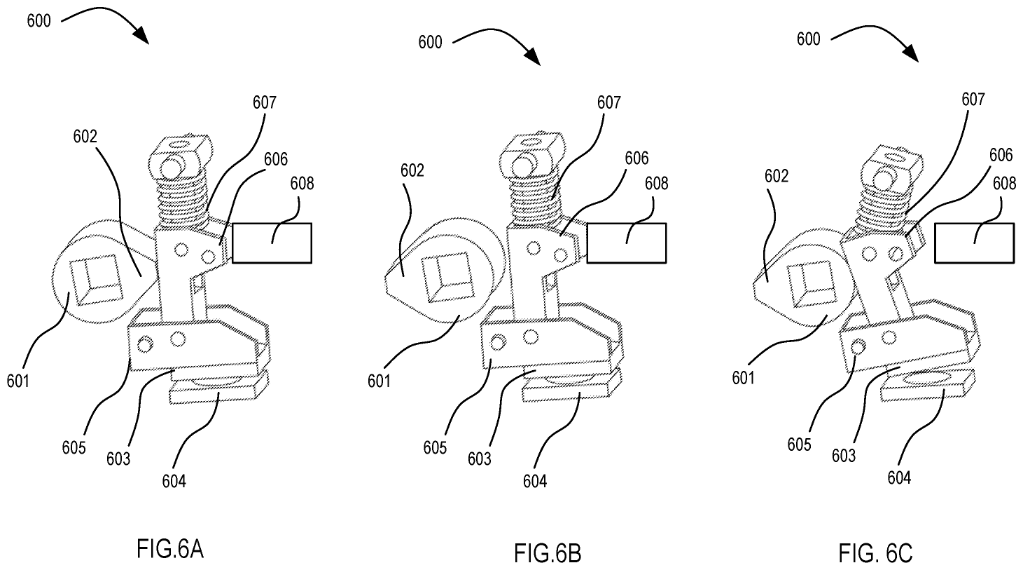

FIGS. 6A, 6B, and 6C set forth another example switch assembly 600 in accordance with at least one embodiment of the present disclosure. The switch assembly 600 has a ‘normally open’ switch configuration. The switch assembly 600 includes a moveable contact 603 and a fixed contact 604. In some examples, the moveable contact 603 is a deformable bus bar and the fixed contact 604 is a fixed bus bar. The moveable contact 603 is supported by a contact rocker 605 that is coupled to a contact actuator 606. A contact spring 607 applies a bias force on the contact actuator 606 to bias the moveable contact 603 in a normally open state. The switch assembly 600 also includes a cam 601 that is couplable to a cam shaft (not shown). The cam 601 includes an actuation member 602, shown in FIGS. 6A, 6B, and 6C as a lobe, but other shapes are contemplated. As the cam shaft rotates the cam 601, the actuation member 602 applies a force to the contact actuator 606 that overcomes the bias force provided by the contact spring 607. The force applied by the actuation member 602 on the contact actuator 606 is transferred to the contact rocker 605, which drives the moveable contact 603 downward toward the fixed contact 604 until the moveable contact 603 makes contact with the fixed contact 604 and closes the switch, as shown in FIG. 6A. Once rotation of the cam 601 closes the switch, contact actuator 606 is retained in position by an energized electromagnet 608, thus holding the moveable contact 603 in the closed position even after the cam 601 rotates the actuation member 602 out of contact with the contact actuator 606, as shown in FIG. 6B. To provide fast breaking, the electromagnet 608 de-energized to release the contact actuator 606, thus returning the switch assembly 600 to the normally open state, as shown in FIG. 6C. It will be appreciated that multiple instances of the switch assembly 600 may be arrayed such that multiple cams 601 of differing shapes or orientations can be coupled to the same cam shaft, as discussed above.

In view of the foregoing, a multi-switch contactor assembly, employing multiple instances of the switch assembly 600 in accordance with FIGS. 6A, 6B, and 6C, is provided in which 1) a single mechanical actuation mechanism operates all switches in such a way that dangerous switch combinations are mechanically impossible; 2) there are only four possible main states: series, only battery A connected, only battery B connected, A+B connected parallel, and intermediate states may be defined in which all contacts are open; 3) the actuator can move in forward and reverse direction to allow either the connection A only or B only to be made first after a series or parallel configuration; 4) a very high contact force (e.g., 100N) enabling very low device resistance (e.g., <50 uOhm) and high levitation currents (>25 kA) is provided; 5) contact can be made using a single contact and flexible bus bars, or a double moveable contact using a rigid contact; 6) a low power electromagnet keeps the switch in closed position once the contacts are closed by the original actuator; 7) automatic opening of the high voltage contact when the electro magnet is de-energized.

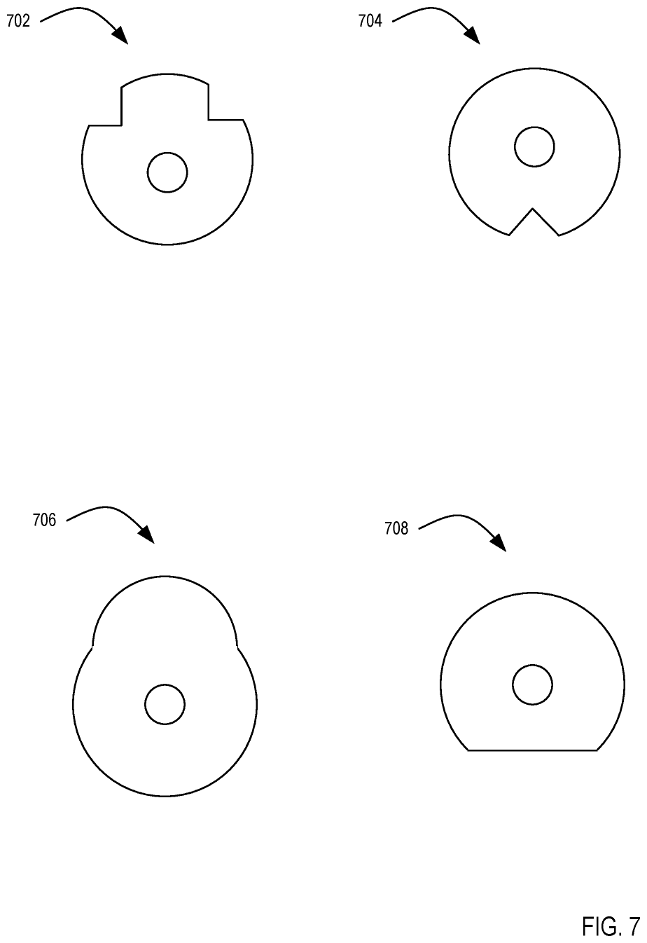

For further explanation, FIG. 7 sets forth a variety of different cam shapes 702, 704, 706, 708 in accordance with the present disclosure.

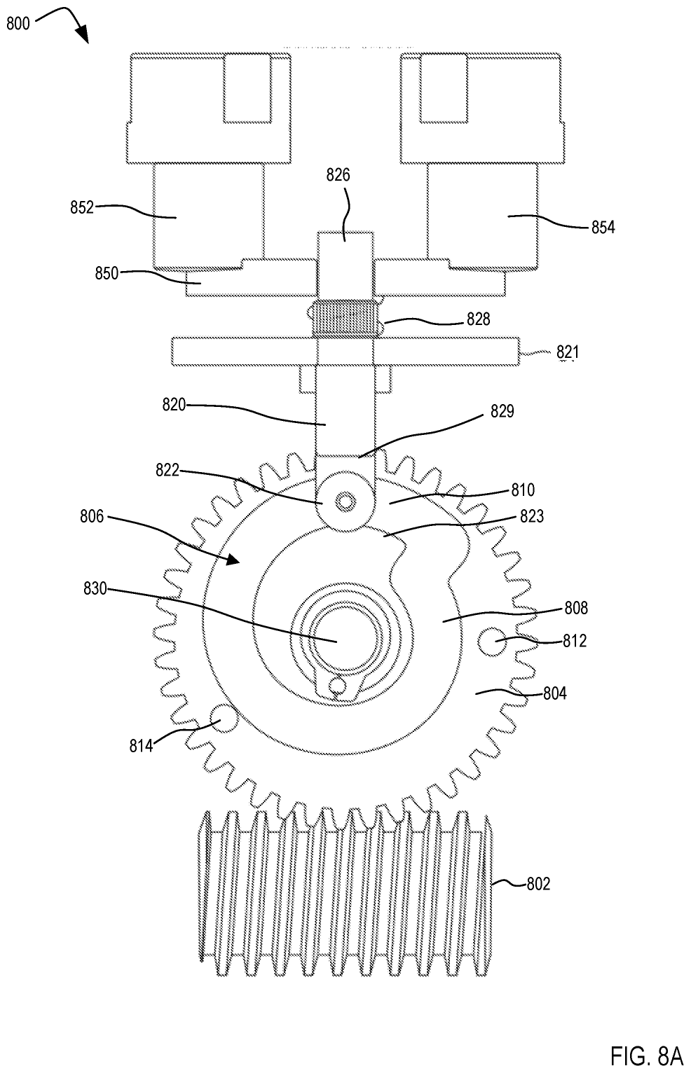

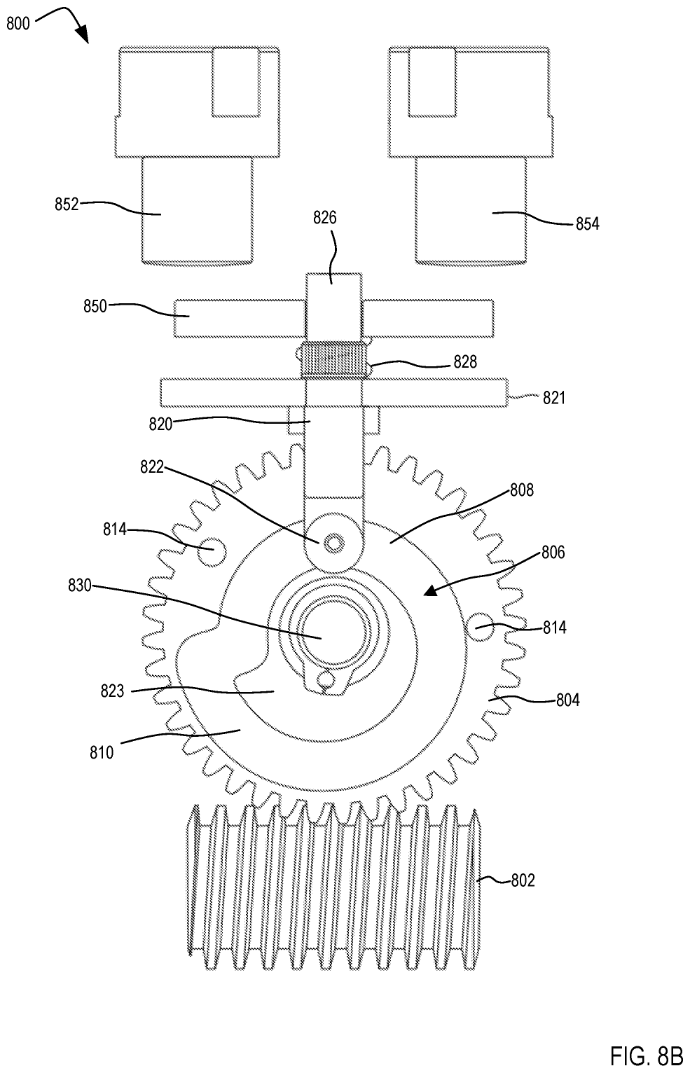

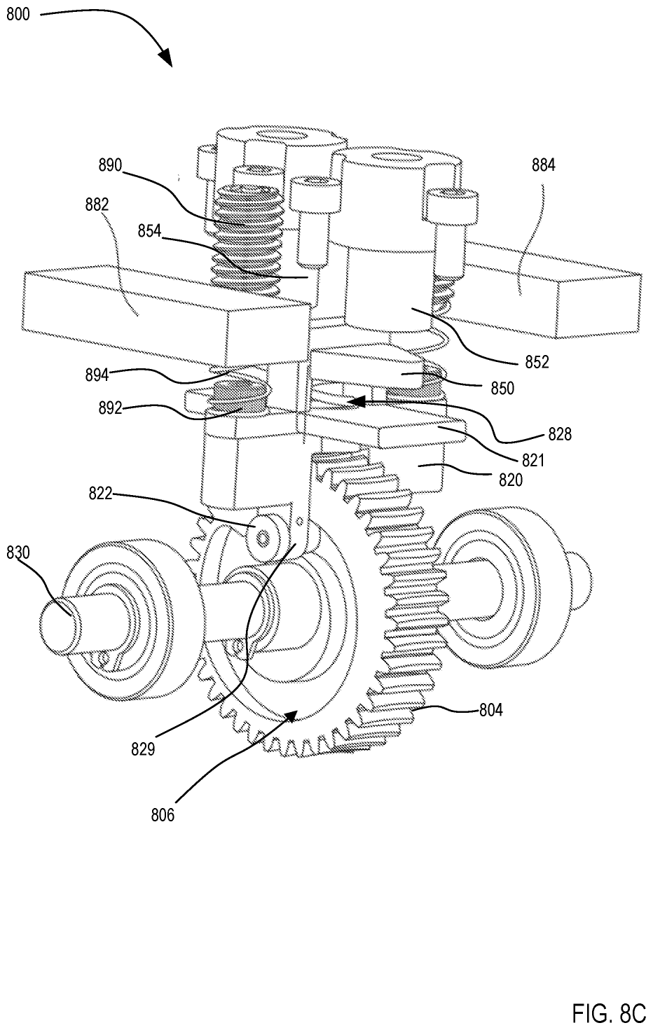

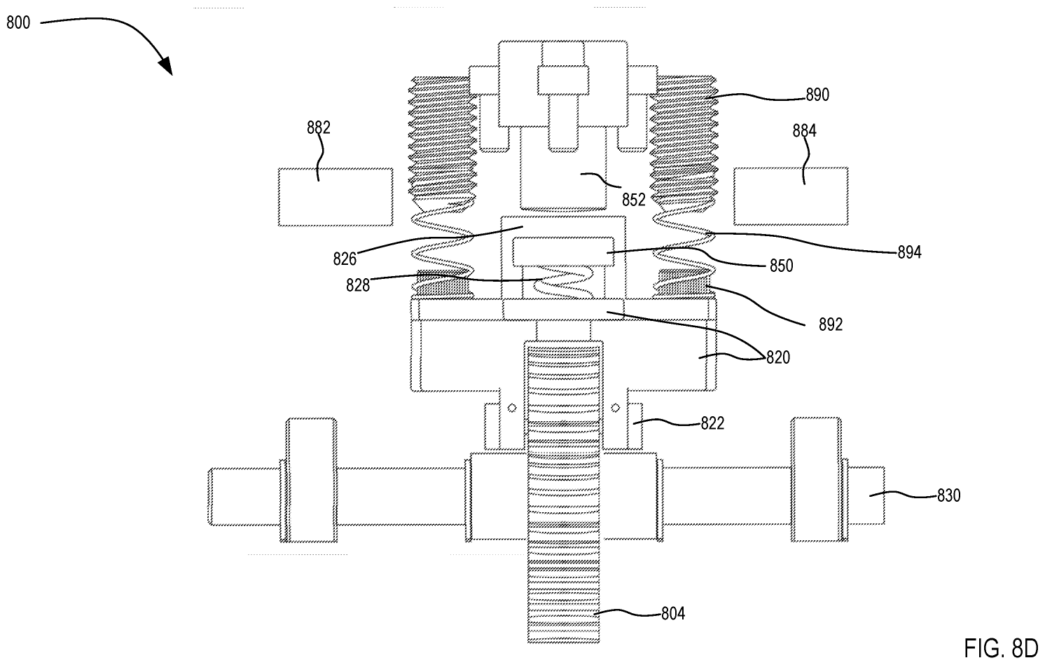

For further explanation, FIGS. 8A and 8B illustrate another example switch assembly 800 for multi-switch contactor assembly in accordance with at least one embodiment of the present invention. In contrast to the previous examples, the switch assembly 800 utilizes a moveable contact 850 that moves between states via a worm gear 804 and a worm driver 802. The moveable contact 850 is seated on a carriage 820 via a yoke 826 and a contact spring 828 coupled to the carriage 820. In some examples, the moveable contact is supported on a magnetic member 821. The carriage 820 includes two legs 829 each having a roller 822 at the foot of the leg 829. The rollers 822 travel in a track 806 of the worm gear 804. The shape of the track is defined by a cam 823. Rotation of the worm driver 802 causes rotation of the worm gear 804 about a shaft 830. As the worm gear 804 rotates, the cam 823 rotates. An actuation portion of the cam 823 engages the roller 822 pushing the roller 822 upward within the track 806 toward an outermost portion 810 of the track 806, which drives the carriage 820 upward toward fixed contacts 852, 854, causing the moveable contact 850 to move into contact with fixed contacts 852, 854. When the worm gear 804 is rotated further, the roller 822 travels past the actuation portion and transitions back to an innermost portion 808 of the track 806, which causes the carriage 820 to drop and pull the moveable contact 850 out of contact with the fixed contacts 852, 854. Thus, contactor assembly 800 implements a switch, such as the switches 110, 112, 114 in FIG. 1. Multiple switch assemblies 800 may be arrayed along the same worm driver 802. Each worm gear 804 may include a cam 823 that is potentially unaligned with the cams of other worm gears in the array. Further, differently shaped cams may be employed. In this way, the different orientations or different shapes of the cams of each switch assembly can be used to implement a multi-switch contactor assembly such as the multi-switch contactor assembly 120 of FIG. 1. In some implementations, the worm gear 804 includes a south pole facing magnet 812 and a north pole facing magnet 814.

For further explanation, FIGS. 8C and 8D illustrate another example of the switch assembly 800 for a multi-switch contactor assembly in accordance with at least one embodiment of the present invention. The switch assembly in FIGS. 8C and 8D further includes a fixed element 890 (e.g., a threaded shaft) that may be coupled to a housing or other support (not shown), and a counterpart spring base 892 coupled to the carriage 820. A spring 894 attached to the fixed element 890 and the spring base 892 stabilizes the carriage 820 as it moves up and down relative to the shaft 830. The switch assembly 800 further includes two electromagnets 882, 884 that, when energized, act on the magnetic member 821 to hold the moveable contact in place. The contactor assembly 800 also includes a carriage 820 that supports a moveable contact 850 via a yoke 826 and contact spring. The carriage 820 includes legs and rollers 822 that travel in a track 806 on both sides of the worm gear 804. The rotation of the worm gear 804 moves the carriage up and down relative to the shaft 830, thus moving the moveable contact 850 in and out of contact with fixed contacts 852, 854.

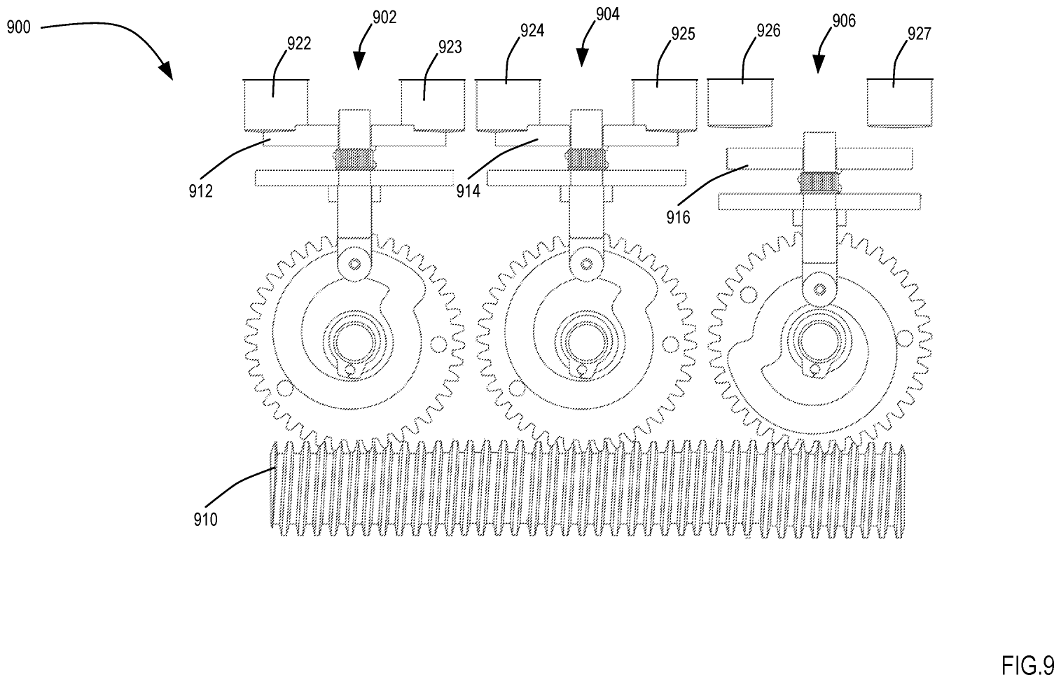

For further explanation, FIG. 9 illustrates a multi-switch contactor assembly 900 including multiple switch assemblies 902, 904, 906 in accordance with at least one embodiment of the present disclosure. In this example, the switch assemblies 902, 904, 906 are configured like the switch assembly 800 of FIGS. 8A and 8B. Thus, the switch assemblies 902 includes a moveable contact 912 and fixed contacts 922, 923, switch assembly 904 includes a moveable contact 914 and fixed contacts 924, 925, and switch assembly 906 includes moveable contact 916 and fixed contact 926, 927. In the assembly 900, movement of the moveable contacts 912, 914, 916 between open and closed states with respect to the fixed contacts is actuated by the same worm drive 910. Thus, in the switch assemblies 902, 904, 906 the actuation of the moveable contacts 912, 914, 916 is mechanically linked. In one example, actuation of the worm drive 910 causes switch assemblies 902, 904 to transition a closed state while switch assembly 906 an open state, and conversely causes switch assemblies 902, 904 to transition an open state before switch assembly 906 transitions to a closed state. Although switch assemblies 902, 904 are shown with the same switch state (i.e., closed) that is opposite that of switch assembly 906 (i.e., open), the switches of the multi-switch contactor assembly 900 may have different combinations of states as discussed above. For example, switch assembly 902 may be fully closed and switch assembly 906 may be fully open, but switch assembly 904 may be transitioning, for example, toward fully closed. Thus, depending on the orientation of the cam on the worm gear, rotation of the worm driver to a particular point may cause switch assembly 902 to close before switch assembly 904 while switch assembly 906 remains open. Further rotation of the worm driver to may cause the switch assembly 904 to also close while switch assembly 906 remains open (as shown in FIG. 9). Further rotation of the worm driver may cause switch assembly 902 to open while switch assembly 904 remains closed (and switch assembly 906 remains open), and so on.

In a particular implementation, e.g., for a battery configuration contactor, fixed contacts 922, 923 and moveable contact 912 form a switch between parallel positive battery pack terminals, such as switch 110 in FIG. 1. Fixed contacts 924, 925 and moveable contact 914 form a switch between parallel negative battery pack terminals, such as switch 112 in FIG. 1. Fixed contacts 926, 927 and moveable contact 916 form a switch between series battery pack terminals, such as switch 114 in FIG. 1. Thus, in this implementation with respect to FIG. 1, the multi-switch contactor assembly 900 ensures that switch 114 cannot be closed while switches 110, 112 for parallel battery pack connection are open. That is, the multi-switch contactor assembly 900 ensures that the series switch 114 will be opened before the parallel switches 110, 112 are closed and that parallel switches 110, 112 will be opened before series switch 114 is closed.

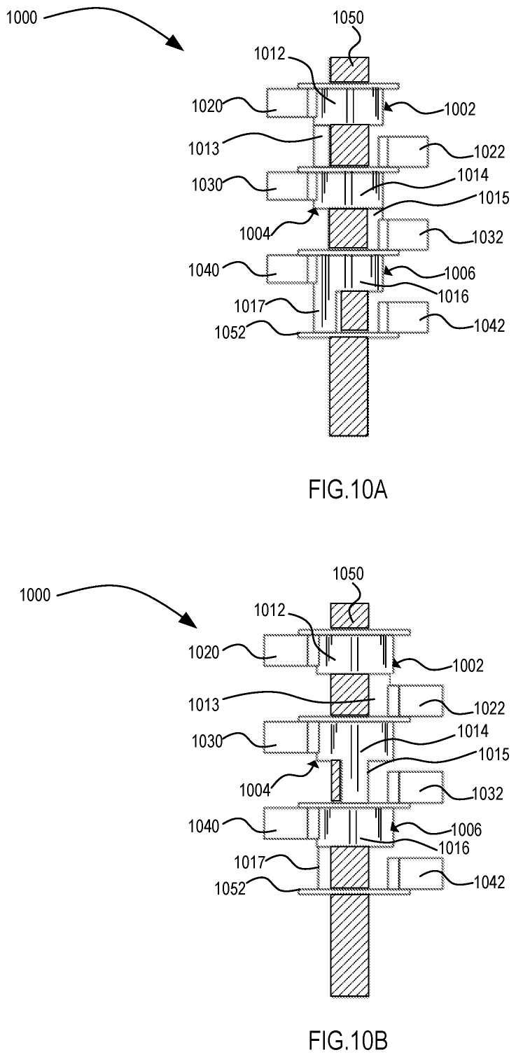

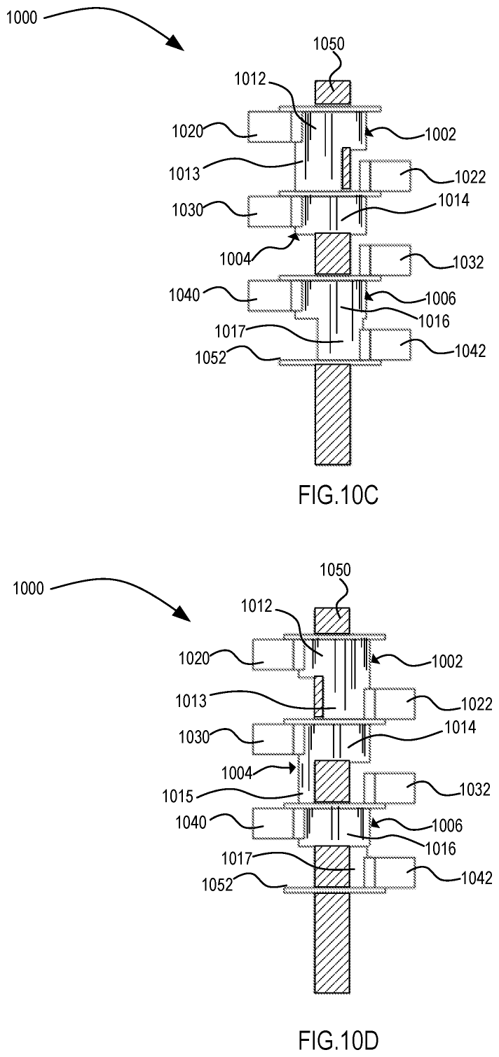

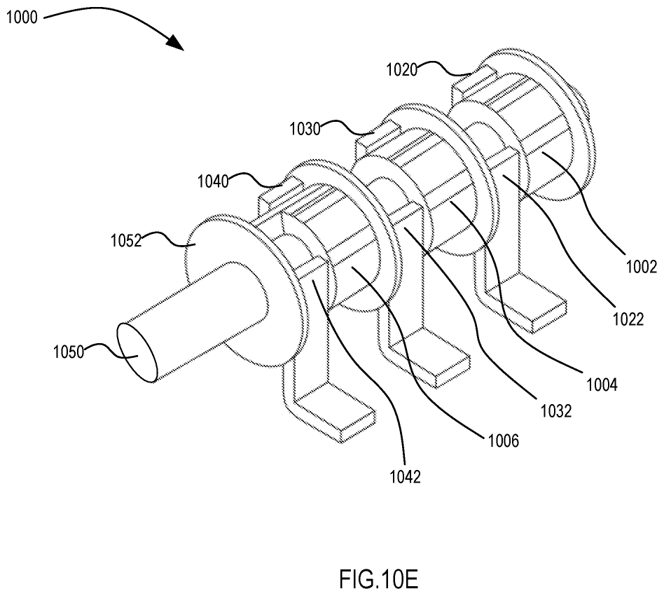

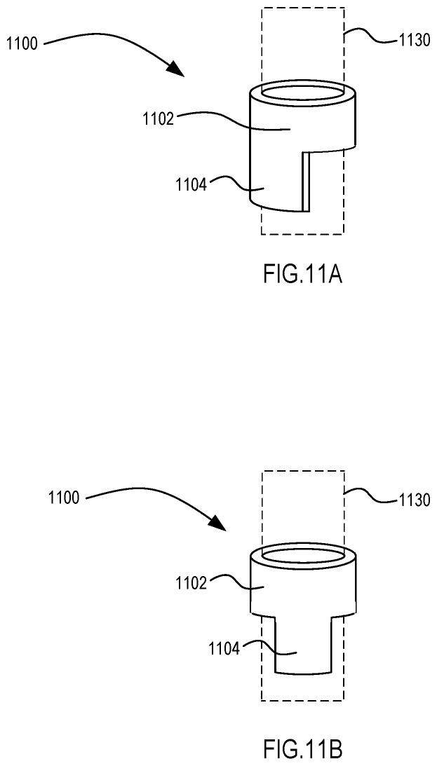

For further explanation, FIGS. 10A, 10B, 10C, 10D, and 10E illustrate another example multi-switch contactor assembly in accordance with at least one embodiment of the present disclosure. The example contactor assembly 1000 includes moveable contacts 1002, 1004, 1006 that move by rotation around a shaft 1050. The contacts are isolated from each other and from the shaft 1050 via insulating material 1052. The rotational moveable contacts include a continuous contact portion for permanent contact with a fixed contact and a discontinuous contact portion for selectable contact with a fixed contact. To illustrate, FIGS. 11A and 11B show an example rotational contact 1100 in which a continuous portion 1102 of the contact 1100 completely defines a shaft passage for shaft 1130, and a discontinuous portion 1104 only partially defines a shaft passage for shaft 1130. FIG. 11B illustrates a rotation of the contact 1100 relative to FIG. 11A. Although not shown, contact 1100 is isolated from shaft 1130 via insulating material. Returning to FIG. 10A, moveable contact 1002 includes a permanent contact portion 1012 that remains in continuous contact with fixed contact 1020 and a discontinuous contact portion 1013 that is selectable to contact or not contact fixed contact 1022 depending on the rotation of the contact via rotation of the shaft 1050. Moveable contact 1004 includes a permanent contact portion 1014 that remains in continuous contact with fixed contact 1030 and a discontinuous contact portion 1015 that is selectable to contact or not contact fixed contact 1032 depending on the rotation of the contact via rotation of the shaft 1050. Moveable contact 1006 includes a permanent contact portion 1016 that remains in continuous contact with fixed contact 1040 and a discontinuous contact portion 1017 that is selectable to contact or not contact fixed contact 1042 depending on the rotation of the contact via rotation of the shaft 1050. The moveable contacts 1002, 1004, 1006 are aligned such that rotation of the moveable contacts causes the respective discontinuous contact portions 1013, 1015, 1017 to contact respective fixed contacts 1022, 1032, 1042 in manner that creates four states of the contactor assembly, as will be explained below.

In FIG. 10A, moveable contact 1002 is in a position in which discontinuous contact portion 1013 is not in contact with fixed contact 1022. Thus, a switch A formed by fixed contacts 1020, 1022 and moveable contact 1002 is in an open state. Moveable contact 1004 is in a position in which discontinuous contact portion 1015 is in contact with fixed contact 1032. Thus, a switch B formed by fixed contacts 1030, 1032 and moveable contact 1004 is in a closed state. Moveable contact 1006 is in a position in which discontinuous contact portion 1017 is not in contact with fixed contact 1042. Thus, a switch C formed by fixed contacts 1040, 1042 and moveable contact 1006 is in an open state. FIG. 10A represents a configuration suitable for a series battery connection, where a switch B connecting the battery packs in series is closed and switch A and switch C connecting the battery packs in parallel are closed.

FIG. 10B illustrates a rotation of the shaft by +90 degrees relative to FIG. 10A. In FIG. 10B, moveable contact 1002 is in a position in which discontinuous contact portion 1013 is in contact with fixed contact 1022. Thus, switch A formed by fixed contacts 1020, 1022 and moveable contact 1002 is in a closed state. Moveable contact 1004 is in a position in which discontinuous contact portion 1015 is not in contact with fixed contact 1032. Thus, switch B formed by fixed contacts 1030, 1032 and moveable contact 1004 is in an open state. Moveable contact 1006 is in a position in which discontinuous contact portion 1017 is not in contact with fixed contact 1042. Thus, switch C formed by fixed contacts 1040, 1042 and moveable contact 1006 is in an open state. FIG. 10B represents a configuration suitable for a direct connection of a first battery pack via switch A, where switch B connecting the battery packs in series is open and switch C connecting a second battery pack is closed.

FIG. 10C illustrates a rotation of the shaft by −90 degrees relative to FIG. 10A. In FIG. 10C, moveable contact 1002 is in a position in which discontinuous contact portion 1013 is not in contact with fixed contact 1022. Thus, switch A formed by fixed contacts 1020, 1022 and moveable contact 1002 is in an open state. Moveable contact 1004 is in a position in which discontinuous contact portion 1015 is not in contact with fixed contact 1032. Thus, switch B formed by fixed contacts 1030, 1032 and moveable contact 1004 is in an open state. Moveable contact 1006 is in a position in which discontinuous contact portion 1017 is in contact with fixed contact 1042. Thus, switch C formed by fixed contacts 1040, 1042 and moveable contact 1006 is in a closed state. FIG. 10B represents a configuration suitable for a direct connection of the second battery pack via switch C, where switch B connecting the battery packs in series is open and switch A connecting the first battery pack is closed.

FIG. 10D illustrates a rotation of the shaft by +180 degrees relative to FIG. 10A. In FIG. 10D, moveable contact 1002 is in a position in which discontinuous contact portion 1013 is in contact with fixed contact 1022. Thus, switch A formed by fixed contacts 1020, 1022 and moveable contact 1002 is in a closed state. Moveable contact 1004 is in a position in which discontinuous contact portion 1015 is not in contact with fixed contact 1032. Thus, switch B formed by fixed contacts 1030, 1032 and moveable contact 1004 is in an open state. Moveable contact 1006 is in a position in which discontinuous contact portion 1017 is in contact with fixed contact 1042. Thus, switch C formed by fixed contacts 1040, 1042 and moveable contact 1006 is in a closed open state. FIG. 10B represents a configuration suitable for a parallel connection of the first battery pack and the second battery pack through switches A and C, where switch B connecting the battery packs in series is open.

Accordingly, as shown by FIGS. 10A, 10B, 10C, and 10D, the multi-switch contactor assembly is selectable between four states using three moveable contacts that are actuated by a single actuator, where all three moveable contacts are moved in unison. In the first state, two battery packs are connected in series while ensuring that there is additional direct connection of the vehicle power distribution to a battery pack. In a second state, a first battery pack is connected directly to the vehicle power distribution system while ensuring that the battery packs are not connected in series. If the voltage of the first battery pack is below the voltage of the second battery pack, the first battery pack can be charged alone and directly until it reaches the voltage of the second battery pack. If two battery packs are not at the same voltage when connected in parallel, the parallel connection could induce a high current that could weld the contacts. In a third state, a second battery pack is connected directly to the vehicle power distribution system while ensuring that the battery packs are not connected in series. If the voltage of the second battery pack is below the voltage of the first battery pack, the second battery pack can be charged alone and directly until it reaches the voltage of the first battery pack. In a fourth state, two battery packs are connected in parallel while ensuring that the battery packs are not also connected in series, which would cause a direct short. When both battery packs are at substantially the same voltage, via independent charging in the second or third state, the contactor assembly may be placed in the fourth state for simultaneous charging of the battery packs. For further explanation, FIG. 10E illustrates a perspective view of the contactor assembly 1000 showing the arrangement of the fixed contacts 1020, 1022, 1030, 1032, 1040, 1042 and moveable contacts 1002, 1004, 1006. Thus, with additional reference to FIG. 1, the contactor assembly 1000 of FIGS. 10A-10E ensures that the series switch 114 will be opened before the parallel switches 110, 112 are closed and that parallel switches 110, 112 will be opened before series switch 114 is closed. In the open position, the air gap between the rotatable moveable contact and the fixed contact avoids the need for large creep distances.

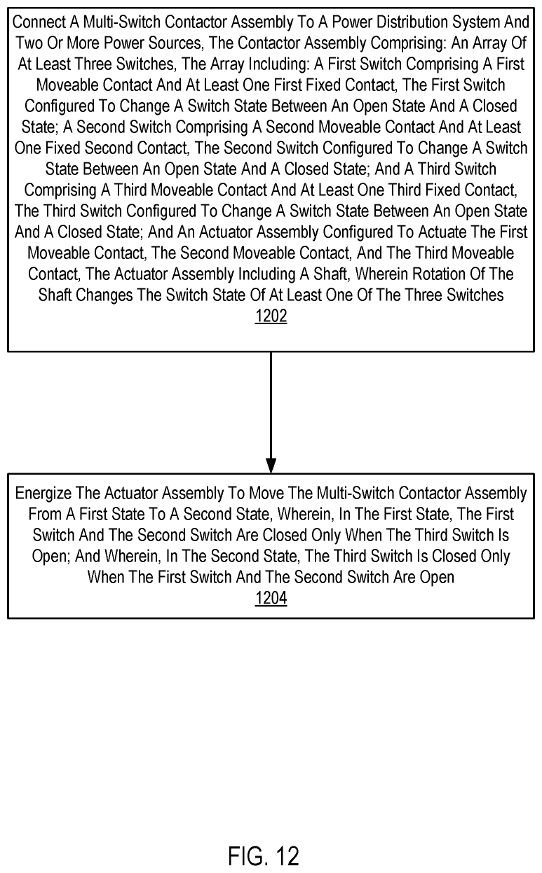

For further explanation, FIG. 12 sets forth a flow chart illustrating an example method of operating a battery configuration contactor in accordance with at least one embodiment of the present disclosure. The method of FIG. 12 includes connecting 1202 a multi-switch contactor assembly to a power distribution system and two or more power sources, the multi-switch contactor assembly comprising an array of at least three switches, the array including a first switch comprising a first moveable contact and at least one first fixed contact, the first switch configured to change a switch state between an open state and a closed state; a second switch comprising a second moveable contact and at least one fixed second contact, the second switch configured to change a switch state between an open state and a closed state; and a third switch comprising a third moveable contact and at least one third fixed contact, the third switch configured to change a switch state between an open state and a closed state; and an actuator assembly configured to actuate the first moveable contact, the second moveable contact, and the third moveable contact, the actuator assembly including a shaft, wherein rotation of the shaft changes the switch state of at least one of the three switches. In some examples, the contactor assembly is one of the contactor assemblies described above with reference to the Figures.

The method of FIG. 12 also includes energizing 1204 the actuator to move the multi-switch contactor assembly from a first state to a second state, wherein, in the first state, the first switch and the second switch are closed only when the third switch is open, and wherein, in the second state, the third switch is closed only when the first switch and the second switch are open. In some examples, energizing 1204 the actuator to move the multi-switch contactor assembly from a first state to a second state is carried out by rotating a cam shaft to rotate a plurality of cams that respectively actuate a plurality of switches, as described above with reference to FIGS. 2-7. In some examples, by energizing 1204 the actuator to move the multi-switch contactor assembly from a first state to a second state is carried out by energizing an actuator motor to rotate an actuator shaft around the axis of the shaft, such that rotation of the shaft turns a worm gear. The moveable contacts move in and out of contact with pairs of fixed contacts in accordance with rotation of the worm gear, as discussed above with reference to FIGS. 8A, 8B, 8C, 8D, and 9. In some examples, energizing 1204 the actuator to move the multi-switch contactor assembly from a first state to a second state is carried out by energizing an actuator motor to rotate an actuator shaft around the axis of the shaft, such that rotation of the shaft turn rotates the moveable contacts. Depending on the rotation of each moveable contact, electrical connections are open and closed between pairs of fixed contacts, such described above with references to FIGS. 10-10E and FIG. 11A and 11B.

In view of the foregoing, it will be appreciated that the multi-switch contactor assemblies and battery configuration contactor described above provide a number of advantages, including the ability to configure two battery packs into serial and parallel states (e.g., one for driving and one for charging an electric vehicle), low contact resistance (e.g., less than 50 μΩ per switch), high levitation withstand realized via appreciable contact force, a mitigation of risk of battery shorting due to loss of switching coordination or mechanical shock, the ability to manage voltage potential mismatch in battery packs, the ability to actively break tack welds, low hold power required for an actuated state, and reduced switching noise.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A multi-switch contactor assembly comprising:
an array of at least three switches, the array including:
a first switch comprising a first moveable contact and at least one first fixed contact, the first switch configured to change a switch state between an open state and a closed state;
a second switch comprising a second moveable contact and at least one fixed second contact, the second switch configured to change a switch state between an open state and a closed state; and
a third switch comprising a third moveable contact and at least one third fixed contact, the third switch configured to change a switch state between an open state and a closed state; and
an actuator assembly configured to actuate the first moveable contact, the second moveable contact, and the third moveable contact, the actuator assembly including a shaft, wherein the respective switch states of the three switches is change in dependence upon rotation of the shaft.

2. The multi-switch contactor assembly of claim 1, wherein rotation of the shaft changes the switch state of the first switch to the closed state while changing the switch state of the third switch to the open state.

3 The multi-switch contactor assembly of claim 1, wherein the multi-switch contactor assembly is configured for four switch state combinations of the three switches.

4. The multi-switch contactor assembly of claim 3, wherein clockwise and counterclockwise rotation of the shaft selects among the four switch state combinations.

5. The multi-switch contactor assembly of claim 1, wherein the actuator assembly includes three cams that are rotatable through rotation of the shaft, the three cams configured to respectively actuate the three switches based on the rotation of the shaft.

6. The multi-switch contactor assembly of claim 5, wherein each of the three cams is coupled to the cam shaft; and wherein at least two cams differ in their shape.

7. The multi-switch contactor assembly of claim 5, wherein each of the three cams includes an actuation member, wherein the actuation members of at least two cams are unaligned along the shaft.

8. The multi-switch contactor assembly of claim 5, wherein the first moveable contact, the second moveable contact, and the third moveable contact are spring loaded such that the three switches have a normally closed state; and wherein respective switches are changed to an open state through actuation of respective moveable contacts by respective cams.

9. The multi-switch contactor assembly of claim 5, wherein the first moveable contact, the second moveable contact, and the third moveable contact are spring loaded such that the three switches have a normally open state; and wherein respective switches are changed to a closed state through actuation of respective moveable contacts by respective cams.

10. The multi-switch contactor assembly of claim 9 further comprising an electromagnet, wherein a particular switch automatically opens when the electromagnet is de-energized.

11. The multi-switch contactor assembly of claim 5, wherein the first moveable contact, the second moveable contact, and the third moveable contact are at least one of rotatable and deformable.

12. The multi-switch contactor assembly of claim 5, wherein actuator assembly includes three worm gears each including one of the three cams; wherein the shaft is a worm drive shaft; and wherein rotation of the worm drive shaft rotates the three worm gears such that the three cams are also rotated.

13. The multi-switch contactor assembly of claim 1, wherein the first moveable contact includes a first portion in continuous contact with a first bus bar and a second portion that makes and breaks contact with a second bus bar depending on the rotation of the shaft; wherein the second moveable contact includes a first portion in continuous contact with a third bus bar and a second portion that makes and breaks contact with a fourth bus bar depending on the rotation of the shaft; and wherein the third moveable contact includes a first portion in continuous contact with a fifth bus bar and a second portion that makes and breaks contact with a sixth bus bar depending on the rotation of the shaft.

14. A system for multi-switch contactor assembly, the system comprising:
a first power source;
a second power source;
a power distribution system; and
the multi-switch contactor assembly comprising:
an array of at least three switches, the array including:
a first switch comprising a first moveable contact and at least one first fixed contact, the first switch configured to change a switch state between an open state and a closed state;
a second switch comprising a second moveable contact and at least one fixed second contact, the second switch configured to change a switch state between an open state and a closed state; and
a third switch comprising a third moveable contact and at least one third fixed contact, the third switch configured to change a switch state between an open state and a closed state; and
an actuator assembly configured to actuate the first moveable contact, the second moveable contact, and the third moveable contact, the actuator assembly including a shaft, wherein rotation of the shaft changes the switch state of at least one of the three switches.

15. The system of claim 14, wherein the first switch is configured to connect the first power source and the power distribution system;
wherein the second switch is configured to connect the second power source and the power distribution system;
wherein the third switch configured to connect the first power source and the second power source in series to the power distribution system.

16. The system of claim 14, wherein the first switch and the second switch are closed only when the third switch is open; and
wherein the third switch is closed only when the first switch and the second switch are open.

17. The system of claim 14, wherein the multi-switch contactor assembly is configured to connect the power distribution system and the first power source and the second power source in only two configuration states;
wherein, in a first configuration state of the multi-switch contactor assembly, the first switch and the second switch are closed, such that the first power source and the second power source are connected to the power distribution system in parallel and the third switch is open; and
wherein, in a second configuration state of the multi-switch contactor assembly, the first switch and the second switch are open and the third switch is closed, such that the first power source and the second power source are connected in series.

18. The system of claim 16, wherein the multi-switch contactor assembly is configured to connect the power distribution system and the first power source and the second power source in only four configuration states;
wherein, in a first configuration state of the multi-switch contactor assembly, the first switch and the second switch are closed, such that the first power source and the second power source are connected to the power distribution system in parallel and the third switch is open;
wherein, in a second configuration state of the multi-switch contactor assembly, the first switch and the second switch are open and the third switch is closed, such that the first power source and the second power source are connected in series;
wherein, in a third configuration state of the multi-switch contactor assembly, the first switch is closed, such that the first power source is directly connected to the power distribution system, and the second switch and the third switch are open; and
wherein, in a fourth configuration state of the multi-switch contactor assembly, the second switch is closed, such that the second power source is directly connected to the power distribution system, and the first switch and the third switch are open.

19. A method for a multi-switch contactor assembly, the method comprising:
connecting the multi-switch contactor assembly to a power distribution system and two or more power sources, the contactor assembly comprising:
an array of at least three switches, the array including:
a first switch comprising a first moveable contact and at least one first fixed contact, the first switch configured to change a switch state between an open state and a closed state;
a second switch comprising a second moveable contact and at least one fixed second contact, the second switch configured to change a switch state between an open state and a closed state; and
a third switch comprising a third moveable contact and at least one third fixed contact, the third switch configured to change a switch state between an open state and a closed state; and
an actuator assembly configured to actuate the first moveable contact, the second moveable contact, and the third moveable contact, the actuator assembly including a shaft, wherein rotation of the shaft changes the switch state of at least one of the three switches;
energizing the actuator assembly to move the multi-switch contactor assembly from a first state to a second state,
wherein, in the first state, the first switch and the second switch are closed only when the third switch is open; and
wherein, in the second state, the third switch is closed only when the first switch and the second switch are open.

20. The method of claim 19, wherein the actuator assembly includes three cams that are rotatable through rotation of the shaft, the three cams configured to respectively actuate the three switches based on the rotation of the shaft.
